(19) United States
(12) Patent Application Publication
(10) Pub. No.: US 2008/0111563 A1
(43) Pub. Date: May 15, 2008

(54) Device and Method for Examining a Solid, Elongate Product to be Tested

(75) Inventors: Philipp Ott, Steg (CH); Peter Schmid, Zurich (CH)

Correspondence Address: LUEDEKA, NEELY & GRAHAM, P.C., P O BOX 1871, KNOXVILLE, TN, 37901, US

(73) Assignee: USTER TECHNOLOGIES AG, Uster (CH)

(21) Appl. No.: 11/910,596

(22) PCT Filed: Mar. 6, 2006
(86) PCT No.: PCT/CH06/00138

§ 371 Date: Oct. 3, 2007

(30) Foreign Application Priority Data
Apr. 5, 2005 (CH) 00621/05

(51) Int. Cl. G01N 27/22

(52) U.S. Cl. 324/688

(57) ABSTRACT

The device for examining a solid, elongate product to be tested contains a measurement capacitor with a measurement part-electrode and guard electrodes electrically insulated therefrom. The device further comprises means for applying an alternating voltage to the measurement capacitor for the purpose of generating an alternating electrical field in the measurement capacitor. The guard electrodes are set up for active guarding, in that, with regard to the alternating voltage, they are kept at the same potential as the measurement part-electrode. Differently thick products to be tested may be tested with one and the same measurement head thanks to the active guarding. The signal noise is reduced, the output signal is largely independent of the position of the product to be tested in the transverse direction, and the measurement head has small geometric dimensions.

This application claims priority under any and all applicable statutes, acts, treaties, and agreements on international application PCT/CH2006/000138 filed Mar. 6, 2006 and Swiss application 00621/05 filed Apr. 5, 2005.

### FIELD OF THE INVENTION

The present invention is in the field of testing solid, elongate, preferably textile formations such as card sliver, roving, yarn or fabric, with capacitive means. It relates to a device and a method for examining a solid, elongate product to be tested, according to the preambles of the independent patent claims. Such an examination may for example have the aim of detecting foreign matter or recognizing changes of the mass per unit length.

### BACKGROUND OF THE INVENTION

In the textile industry, there exists the requirement of a reliable recognition of foreign matter such as polypropylene in elongate, textile formations such as yarn. Optical means are often applied for this purpose. These however have the disadvantage that they do not recognize foreign matter which is transparent, has the same color as the product to be tested or is hidden in the inside of the product to be tested and is not visible from the outside.

The inadequacy of optical testing methods may be circumvented by way of the application of electrical, in particular capacitive means. A method and a device for the capacitive recognition of foreign matter in a textile product to be tested is known from EP-0'924'513 A1. Thereby, the product to be tested is moved through a plate capacitor and is subjected to an alternating electrical field. Dielectric properties of the product to be tested are evaluated. Two electrical values are evaluated from the dielectric properties and combined, wherein a characteristic value arises which is independent of the mass of the product to be tested. The characteristic value is compared to a previously evaluated characteristic value for the material concerned, and the portion of foreign matter is determined from this.

In a preferred embodiment of the device disclosed in EP-0'924'513 A1, a reference capacitor is applied simultaneously with the actual measurement capacitor, in order to eliminate unwanted signals caused by external influences, such as air temperature or air humidity. This reference capacitor may be formed by way of adding a third capacitor plate parallel to the two measurement capacitor plates, wherein the three capacitor plates are connected together into a capacitive bridge. Typical dimensions of the capacitor plates are approx. 7 mm×7 mm, typical plate distances approx. 2 mm.

With the above-described device, one may observe the fact that the signal noise increases with an increased electrode distance. Furthermore, the output signal changes when the product to be tested is displaced in the transverse direction, i.e., from one capacitor electrode to the other. The consequences of this are artifacts and a likewise high noise due to the transverse oscillation of the product to be tested on running through the measurement capacitor.

These undesired observations are mainly to be led back to edge effects in the measurement capacitor. It is e.g. known from the publications U.S. Pat. No. 2,950,436, U.S. Pat. No. 3,523,246, GB-1,373,922 or GB-2,102,958, to provide so-called guard electrodes on the edges of the measurement capacitor for reducing the edge effects. By way of this, the effective measurement region is limited to the middle region of the measurement capacitor, where the electric field is homogeneous. The guard electrodes are connected to earth or another constant potential, and shield the actual measurement part-electrode, which is located in the middle region of the measurement capacitor, from disturbing edge effects. Despite this measure, the described, undesired observations could not be completely alleviated.

Specifically, differences in potential exist between the measurement part-electrode and the guard electrodes, so that inherently present parasitical capacitances between the electrodes have a disadvantageous effect on the measurement. The distances between the measurement part-electrode and the guard electrodes must be increased in order to reduce the influence of the parasitical capacitances. This however prevents the desired guard effect of the guard electrodes, since the electrical field at the edges of the measurement part-electrodes becomes inhomogeneous by way of this. Furthermore, a measurement head with electrodes enlarged in such a manner takes up more space, which is disadvantageous with regard to the application.

### SUMMARY OF THE INVENTION

It is therefore an object of the present invention to indicate a device and a method for examining solid, elongate, preferably textile formations which do not have the above disadvantages and which improve the known devices and methods. Signal noise is to be particularly reduced. The output signal should be largely independent of the position of the product to be tested in the transverse direction. The space requirement should be kept low.

These and other objects are achieved by the device and the method as are defined in the independent patent claims. Advantageous embodiments are specified in the dependent patent claims.

The invention is based on the idea of operating with an active guarding at least one of the guard electrodes, i.e., of applying a temporally changing voltage to the at least one guard electrode.

Accordingly, the device according to the invention, for examining a solid, elongate product to be tested, comprises a measurement capacitor with a measurement part-electrode and at least one guard electrode electrically insulated from the measurement part-electrode, means for applying an alternating (AC) voltage to the measurement capacitor for the purpose of generating an alternating electrical field in the measurement capacitor, and a through-opening for the product to be tested, in the measurement capacitor, said through-opening capable of being subjected to the alternating electrical field. At least one of the at least one guard electrodes is set up for active guarding. Preferably, an alternating (AC) voltage may be applied to the at least one guard electrode, in a manner such that the at least one guard electrode, at least with regard to the alternating (AC) voltage, lies at approximately the same potential as the measurement part-electrode.

The invention also includes the use of active guarding by way of at least one guard electrode with the capacitive examination of a solid, elongate product to be tested.

In the method according to the invention, for examining a solid, elongate product to be tested, the product to be tested is subjected to an electric alternating field in a measurement capacitor with a measurement part-electrode and at least one guard electrode which is electrically insulated from the measurement part-electrode. Active guarding is carried out with at least one of the at least one guard electrodes. Preferably, an alternating (AC) voltage is applied to the at least one guard electrode, in a manner such that the at least one guard electrode, at least with regard to the alternating (AC) voltages, lies at approximately the same potential as the measurement part-electrode.

The active guarding according to the invention prevents the undesired effects of the parasitical capacitances between the measurement part-electrode and the guard electrodes. It allows significantly smaller construction shapes of the measurement head.

### BRIEF DESCRIPTION OF THE DRAWINGS

Preferred embodiments of the invention are hereinafter described in detail by way of the attached drawings. Thereby, in a schematic manner there are shown in:

FIG. 1 depicts a first embodiment of a measurement head for the device according to the invention, in a perspective view,

FIG. 2 depicts courses of electrical field lines in a measurement capacitor (a) according to the state of the art and (b) according to the present invention, in a lateral view,

FIGS. 3-5 depict three further embodiments of a measurement head for the device according to the invention, in perspective views, and

FIGS. 6-7 depict electrical-circuit diagrams of two embodiments of the device according to the invention.

### DESCRIPTION OF PREFERRED EMBODIMENTS

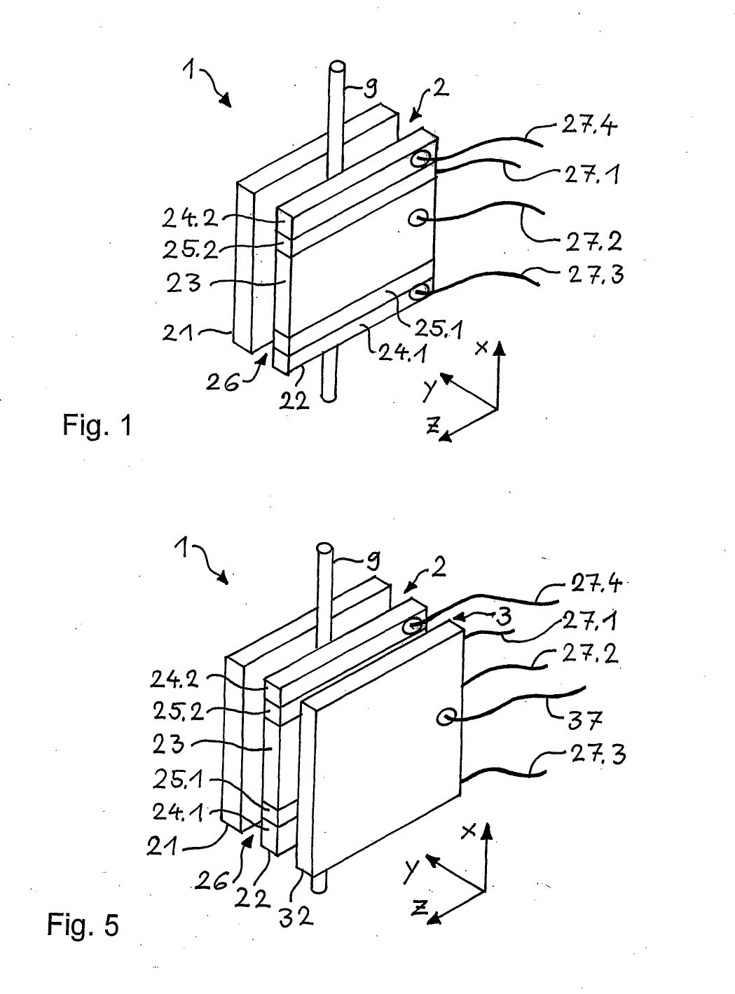

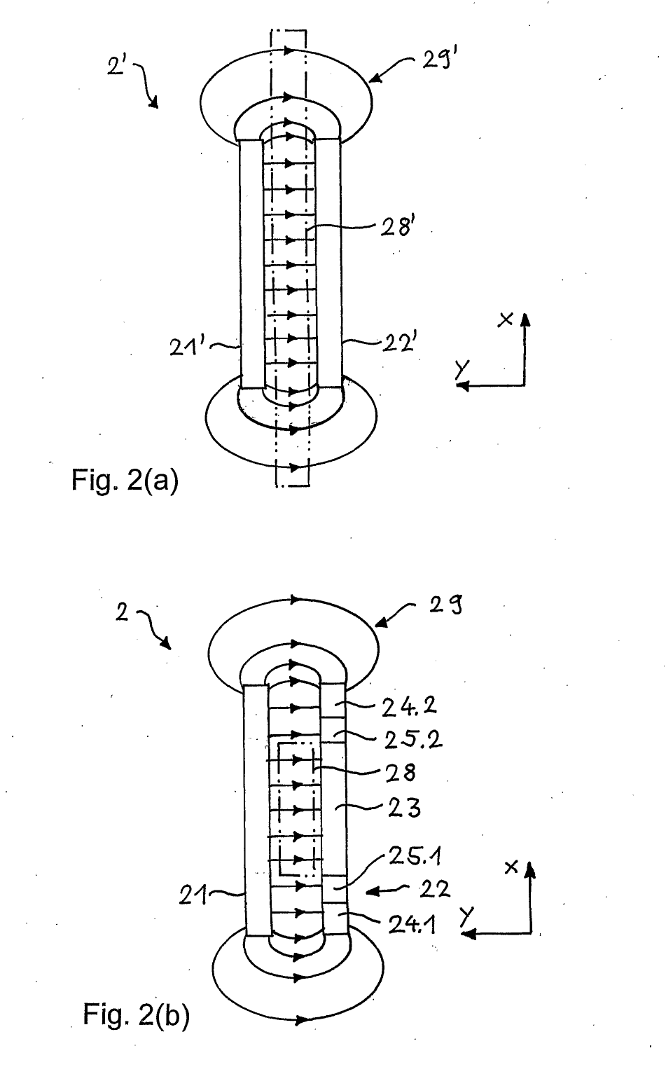

A first embodiment of a measurement head 1 for the device according to the invention is represented in FIG. 1 in a perspective view. The measurement head 1 essentially contains a measurement capacitor 2. Thereby, the measurement capacitor 2 in this embodiment is a plane, two-plate capacitor with a first, essentially plane capacitor plate 21, and a second, essentially plane capacitor plate 22. The capacitor plates 21, 22 are in each case approx. 0.8 mm thick, consist, e.g., of brass, and may be coated, e.g., with nickel for achieving a higher wear strength. The two capacitor plates 21, 22 are separated from one another by an approx. 1-3 mm, preferably approx. 1.5-2.0 mm thick air gap which forms a through-opening 26 for a solid, elongate product to be tested 9. The product to be tested 9 may, e.g., be a yarn. It is preferably moved through the through-opening 26 in the longitudinal direction x and thereby is subjected to an alternating electrical field 29 (cf. FIG. 2(b)) generated between the two capacitor plates 29.

The measurement capacitor 2 contains at least one guard electrode 24.1, 24.2 for reducing the influence of edge effects of the alternating electrical field 29 on an output signal of the measurement capacitor 2. In the embodiment of FIG. 1, the second capacitor plate 22 is divided into three part-electrodes 23, 24.1, 24.2 which are electrically insulated from one another: a central measurement part-electrode 23, and two outer part-electrodes 24.1, 24.2 which form two guard electrodes. Insulation material 25.1, 25.2, e.g., ceramic or plastic, is located between in each case two adjacent part-electrodes 23, 24.1 and 23, 24.2 respectively, so that the three part-electrodes 23, 24.1, 24.2 mechanically form one unit, indeed the capacitor plate 22. The lengths in the x-direction of the individual parts 23, 24.1, 24.2, 25.1, 25.2 may, for instance, be as follows: guard electrodes 24.1, 24.2 in each case approx. 1 mm, insulation material 25.1, 25.2 in each case approx. 0.5 mm, measurement part-electrode 23 approx. 4 mm. The second capacitor plate 22 thus has a total length of approx. 7 mm; its height in the z-direction may also be roughly 7 mm. The dimensions of the first capacitor plate 21 are preferably essentially the same. The length ratios of the measurement part-electrode 23 and guard electrodes 24.1, 24.1 may be optimized depending on the application. In any case, the length of the insulation material 25.1, 25.2 should be as small as possible, in order to ensure an optimal guarding effect by way of the guard electrodes 24.1, 24.2, and in order to keep small the geometric dimensions of the measurement head 1.

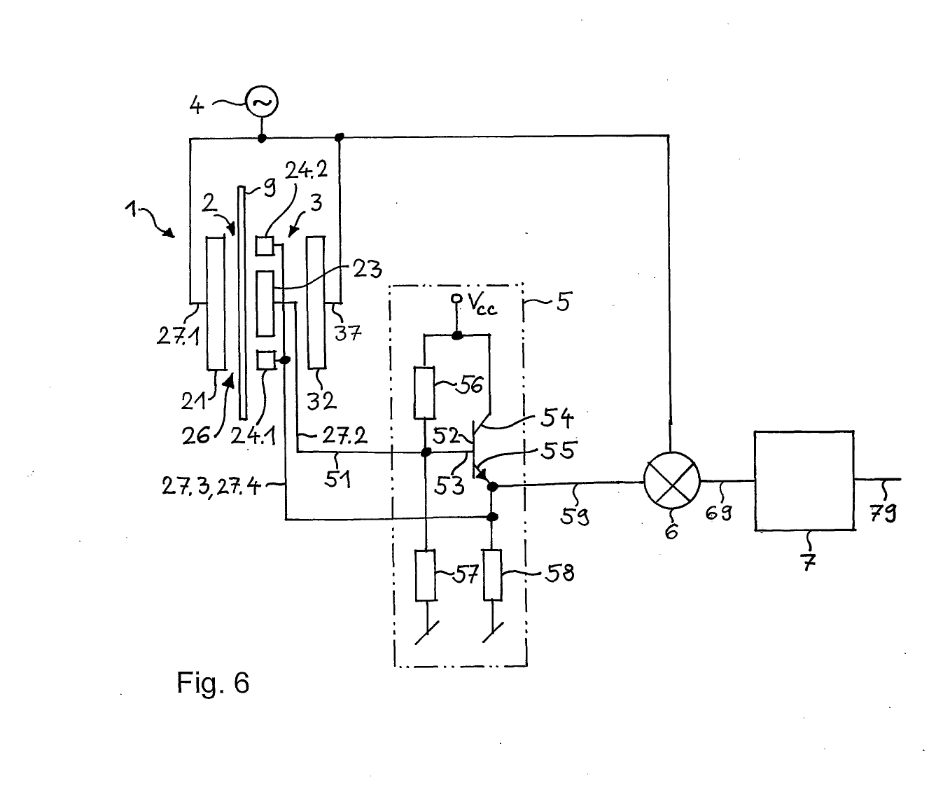

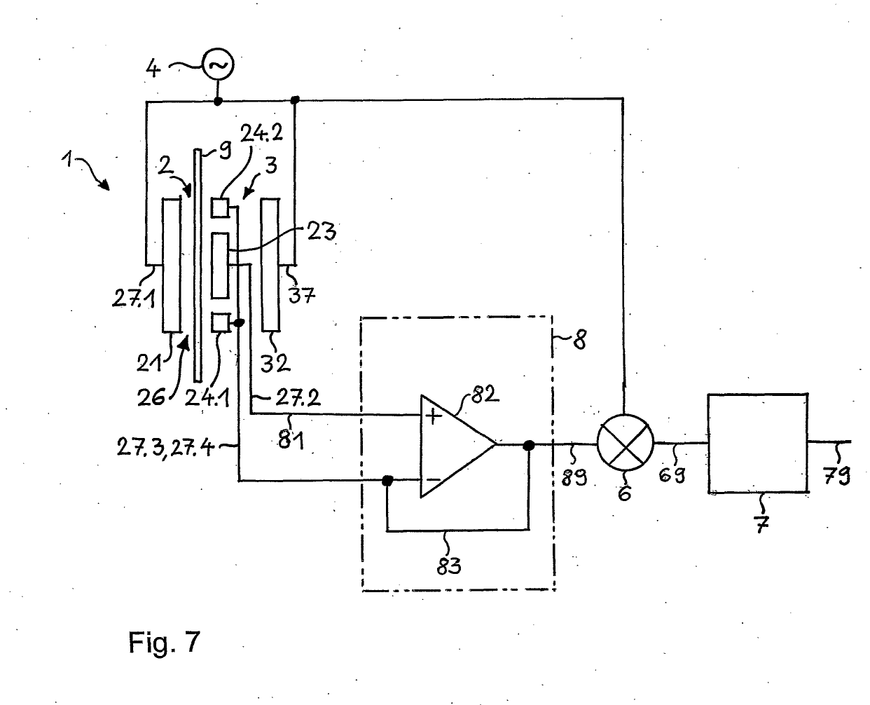

The first capacitor plate 21 and the three part-electrodes 23, 24.1, 24.2 of the second capacitor plate 22 are contacted by separate electrical leads 27.1-27.4, so that an individual electrical voltage may be applied to them or may be tapped from them. The electrical connection diagram will be dealt with in more detail with reference to FIGS. 6 and 7.

FIG. 2 shows in a lateral view a momentary picture of courses of electrical field lines of an alternating electrical field 29′ and 29 in a measurement capacitor 2′ and 2 respectively, to whose capacitor plates 21′, 22′ and 21, 22 respectively, an electrical voltage is applied. The situation for a usual two-plate capacitor 2′ is drawn in FIG. 2(a), and in FIG. 2(b) for a measurement capacitor 2 with guard electrodes 24.1, 24.2 according to the present invention. Under the assumption that the same voltage is applied to the guard electrodes 24.1, 24.2 as to the measurement part-electrode 23, the generated electrical fields 29′, 29 are not significantly different from one another. That which is different is the local measurement region 28′ and 28, indicated by a dot-dashed rectangle in FIG. 2. A measurement with a device according to FIG. 2(a) encompasses a region which extends beyond the measurement capacitor 2′, and is therefore disturbed by the inhomogeneous electrical part fields at the edges of the measurement capacitor 2′. Only the homogeneous electrical part field in the inside of the measurement capacitor 2 is taken into account for the measurement, with the device according to FIG. 2 (b).

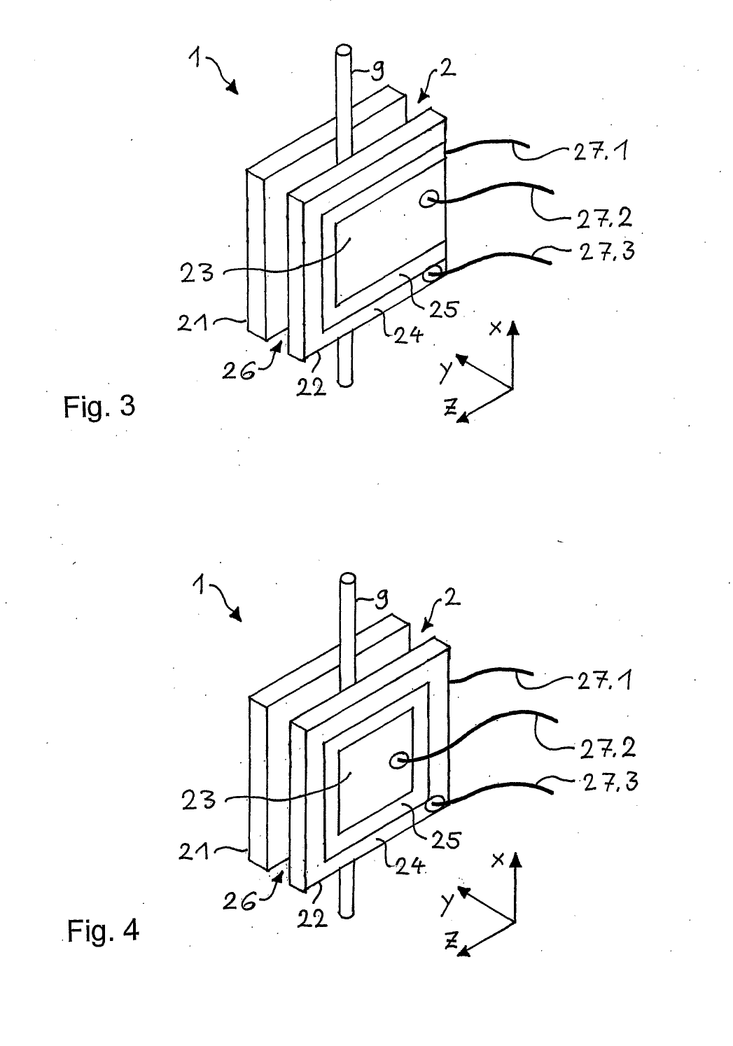

FIG. 3 in an analogous representation according to FIG. 1 shows a second embodiment of a measurement head 1 for the device according to the invention. This embodiment proceeds from the embodiment of FIG. 1, in that the two guard electrodes 24.1, 24.2 are connected to one another along a front edge of the second capacitor plate 22. A C-shaped guard electrode 24 arises by way of this, whose lower and upper limbs lie in the input and output region of the through-opening 26, respectively. The central connection part of the C-shaped guard electrode 24 offers various advantages. Firstly, it further improves the homogeneity of the electrical field in the measurement region. Secondly, it reduces the influence of edge effects at the front edge of the measurement capacitor 2, and thus reduces the dependency of the output signal on the position of the yarn 9 in the z-direction. Thirdly, it reduces the sensitivity of the measurement to contacting (e.g., by an operating person) of the measurement head 1 from the front.

A further development of the embodiment of FIG. 3 is drawn in FIG. 4. Here, the two limbs of the C-shaped guard electrode 24 have been connected to one another along a rear edge of the second capacitor plate 22, by which means the C has been closed into a rectangle or ring. The advantages described with regard to FIG. 3 are present here in a more pronounced manner.

Alternatives to the embodiments described with reference to FIGS. 1, 3 and 4 are indeed conceivable. One alternative (not shown here) would lie in incorporating the through-opening 26 in a block of electrically insulating material such a ceramic or plastic, and in installing the first capacitor plate 21 as well as the part-electrodes 23, 24.1, 24.2, 24 as metal platelets into the walls of the block, or in attaching these as metal layers to the walls of the block.

A fourth embodiment of a measurement head 1 for the device according to the invention is shown in FIG. 5. This measurement head 1 contains a measurement capacitor 2 as has been described with reference to FIG. 1, and additionally a reference capacitor 3. Thereby, the middle capacitor plate 22 is common to both capacitors 2, 3. In this embodiment example, the middle, common capacitor plate 22 is that one which contains the guard electrodes 24.1, 24.2. Such a symmetry of the arrangement is advantageous, but not absolutely necessary. The reference capacitor 3 serves for eliminating disturbance signals caused by external influences such as air temperature or air humidity. Of course, the middle capacitor plate 22 may also be designed according to the embodiments of FIG. 3 or 4, or also in another manner.

An electrical-circuit diagram of a first embodiment of the device according to the invention with a measurement capacitor 2 and a reference capacitor 3 (cf. FIG. 5) is specified in FIG. 6. The device contains an alternating-current (AC) generator 4 for applying an alternating current to the measurement capacitor 2 and to the reference capacitor 3. The frequency of the applied alternating voltage is preferably between 1 MHz and 100 MHz, e.g., 10 MHz. One may thus say that a parallel oscillation circuit with two capacitors 2, 3, is present, which may be detuned by the product to be tested 9. An impedance transducer 5 to whose input lead 51 the measurement part-electrode 23 is connected, is preferably connected after the capacitors 2, 3. An output lead 59 of the impedance transducer 5 connects the impedance transducer 5 to a detector circuit 6. The detector circuit 6 serves for the analog detection of the output signal of the capacitors 2, 3. In the embodiment example of FIG. 6, it essentially leads to a multiplication of the output signal of the measurement capacitor 2 with the alternating voltage signal applied to the capacitors 2, 3. The output signal demodulated in such a manner is outputted to an output lead 69 of the detector circuit 6. The impedance transducer 5 adapts the high impedance of the measurement capacitor 2 to the low impedance of the detector circuit 6.

The demodulated output signal is led on the output lead 69 to an evaluation circuit 7. The evaluation circuit 7 evaluates from the demodulated output signal the actual result of the examination and emits an output signal at an output lead 79 of the device. The result may for example lie in measuring changes of the mass per unit length, or in recognizing foreign matter in examined yarn 9. It is even possible with suitable evaluation methods to also determine the quantitative portion of the foreign matter, and as the case may be, the material of the foreign matter. The evaluation circuit 7 may be designed as an analog electrical circuit or as a digital circuit with a processor. Methods and devices for the capacitive recognition and quantification of solid, foreign matter in textile product to be tested 9 are known from EP-0'924'513 A1 and may be adopted also by the present invention. EP-0'924'513 A1, and in particular the paragraphs [0022]-[0034] thereof, are incorporated by reference into the present document.

Here, a detailed description of the evaluation methods becomes superfluous on account of the above reference to EP-0'924'513 A1. With regard to this, it is merely to be stated that at least two measurement modes are possible. In a first measurement mode, one measures with two different excitation frequencies. The two equal-type output signals, e.g., the measured voltages, are firstly detected separately for each of the excitation frequencies, and are then combined or linked to one another in a suitable manner for the evaluation. In a second measurement mode, one measures with a single excitation frequency, but the output voltage and output current are used as output signals. The phase shift between the voltage signal and the current signal, after a suitable evaluation, provides the sought information with regard to the yarn 9. A combination of the two measurement modes, i.e., the measurement at several frequencies and the measurement of the respective phase shifts between the voltage signal and the current signal, is also possible.

In the preferred embodiment of FIG. 6, the impedance transducer 5 is designed as a collector circuit. The input lead 51 is connected to a base 53 of a transistor 52, preferably a bipolar transistor, in the collector circuit 5. A constant operating voltage V_{cc} is applied to a collector 54 of the bipolar transistor 52. An emitter 55 of the bipolar transistor 52 is connected to the output lead 59. Various resistors 56-58 serve for setting the operating point of the impedance transducer 5.

An active guarding is applied according to the present invention, i.e., an alternating voltage is applied to the guard electrodes 24.1, 24.2, and specifically in a manner such that at least with regard to the alternating voltage, they lie at approximately the same potential as the measurement part-electrode 23. With the embodiment example of FIG. 6, this is achieved by way of electrically connecting the output lead 59 of the collector circuit 5 to the guard electrodes 24.1, 24.2. The output signal of the collector circuit 5 may be used as an input signal for the guard electrodes 24.1, 24.2, since the collector circuit 5 has a small output resistance.

FIG. 7 shows an alternative to the collector circuit 5 of FIG. 6, specifically a transimpedance amplifier circuit 8 with an operational amplifier 82, acting as an impedance transducer. A non-inverting input + of the operational amplifier 82 is electrically connected to the measurement part-electrode 23 by way of an input lead 81. An inverting input − of the operational amplifier 82 on the one hand is connected to the output leads 89 via a feedback lead 83, and on the other hand is electrically connected to the guard electrodes 24.1, 24.2. This alternative may however have the disadvantage that the operational amplifier is comparatively expensive and—at least in the embodiments available on the market today—either has an input impedance which is too low, or a bandwidth which is too narrow, so that one may be asking too much of it with excitation frequencies in the MHz region.

The invention is of course not limited to the above-described embodiments. It is for instance possible to provide more than two guard electrodes in the measurement capacitor 2. One may increase the local resolution of the measurement by way of subdividing the second capacitor plate 22 into several measurement part-electrodes and a corresponding multitude of guard electrodes. One may also provide more than one capacitor plate with one or more guard electrodes. It is also not necessary to use measurement capacitors with plane capacitor plates for the invention, and other capacitor shapes may also be considered. The above-described embodiments may also be combined with one another.

### LIST OF REFERENCE NUMERALS

1 measurement head

2 measurement capacitor

21 first capacitor plate

22 second capacitor plate

23 measurement part-electrode

24, 24.1, 24.2 guard electrodes

25, 25.1, 25.2 insulation material

26 through-opening

27.-1-27.4 electrical leads

28 measurement region

29 alternating electrical field

2′ measurement capacitor according to the prior art

21′, 22′ capacitor plates according to the prior art

28′ measurement region according to the prior art

29′ alternating electrical field according to the prior art

3 reference capacitor

32 capacitor plate

37 electrical lead

4 alternating voltage generator

5 collector circuit

51 input lead

52 bipolar transistor

53 base

54 collector

55 emitter

56-58 resistors

59 output lead of the collector circuit

6 detector circuit

69 output lead of the detector circuit

7 evaluation circuit

79 output lead of the device

8 transimpedance amplifier circuit

81 input lead

82 operational amplifier

83 feedback lead

89 output lead of the transimpedance amplifier circuit

1-20. (canceled)

21. A device for examining a solid, elongate product to be tested, comprising
a measurement capacitor with a measurement part-electrode and at least one guard electrode electrically insulated from the measurement part-electrode and set up for active guarding,
means for applying an alternating voltage to the at least one measurement capacitor so as to generate an alternating electrical field in the at least one measurement capacitor, and
a through-opening for the product to be tested, in the measurement capacitor, the through-opening capable of being subjected to the alternating electrical field.

22. The device according to claim 21, wherein the alternating voltage is applicable to the at least one guard electrode in a manner such that the at least one guard electrode, at least with respect to alternating current, lies at approximately a same potential as the measurement part-electrode.

23. The device according to claim 21, wherein an impedance transducer is connected to the measurement capacitor.

24. The device according to claim 23, wherein the impedance transducer functions as a collector circuit.

25. The device according to claim 24, wherein the collector circuit contains a bipolar transistor, to whose base the measurement part-electrode is electrically connected, to whose collector a constant operating voltage is applicable, and whose emitter is electrically connected to the at least one guard electrode and an output lead of the collector circuit.

26. The device according to claim 23, wherein the impedance transducer functions as a transimpedance amplifier circuit.

27. The device according to claim 26, wherein the transimpedance amplifier circuit contains an operational amplifier, whose non-inverting input is electrically connected to the measurement part-electrode, and whose output is electrically connected to an inverting input of the operational amplifier, to the at least one guard electrode, and to an output lead of the transimpedance amplifier circuit.

28. The device according to claim 21, wherein the at least one guard electrode is arranged in an end region of the through-opening, in which the product to be tested at least one of enters into and exits from the through-opening.

29. The device according to claim 28, wherein the at least one guard electrode comprises a first guard electrode in an input region of the through-opening and a second guard electrode in an output region of the through-opening, and the measurement part-electrode is arranged between the first and second guard electrodes.

30. The device according to claim 21, wherein the device, apart from the measurement capacitor, comprises a reference capacitor.

31. The device according to claim 21, further comprising a detector circuit for detecting an output signal of the measurement capacitor, and an evaluation circuit for evaluating the output signal.

32. A method for examining a solid, elongate product to the tested, wherein
the product to be tested is subjected to an alternating electrical field in a measurement capacitor with a measurement part-electrode and at least one guard electrode electrically insulated from the measurement part-electrode, and
active guarding is carried out with at least one of the at least one guard electrodes.

33. The method according to claim 32, wherein an alternating voltage is applied to the at least one guard electrode, in a manner such that the at least one guard electrode, at least with regard to the alternating voltage, lies at approximately the same potential as the measurement part-electrode.

34. The method according to claim 32, wherein at least one output signal of the measurement capacitor is led to an impedance transducer.

35. The method according to claim 34, wherein a collector circuit with a bipolar transistor is selected as the impedance transducer, an output signal of the measurement part-electrode is led to a base of the bipolar transistor, a constant operating voltage is applied to a collector of the bipolar transistor, and an output signal is taken from an emitter of the bipolar transistor, the output signal being outputted to the at least one guard electrode and as an output signal of the collector circuit.

36. The method according to claim 34, wherein a transimpedance amplifier circuit with an operational amplifier is selected as the impedance transducer, an output signal of the at least one measurement part-electrode is led to a non-inverting input of the operational amplifier, and an output signal of the operational amplifier is led to an inverting input of the operational amplifier and to the at least one guard electrode, and is outputted as an output signal of the transimepdance amplifier circuit.

37. The method according to claim 32, wherein the alternating field is operated a frequency of between about one megahertz and about one hundred megahertz.

38. The method according to claim 32, wherein the alternating field is operated at a frequency of about ten megahertz.

39. The method according to claim 32, wherein a surrounding medium in a reference capacitor is subjected to an alternating electrical field, and at least one output signal of the reference capacitor is evaluated together with at least one output signal of the measurement capacitor.

40. The method according to claim 32, wherein an alternating field with at least one constant excitation frequency is applied to the measurement capacitor, a separate output signal is detected for each of the at least one constant excitation frequency, and the detected output signals are combined with one another for evaluation.
